(19) United States
(12) Patent Application Publication
(10) Pub. No.: US 2009/0296964 A1
(43) Pub. Date: Dec. 3, 2009

(54) Compact surround-sound effects system

(75) Inventors: Irving Alexander Bienek, Impington (GB); Paul Raymond Windle, Cambridge (GB); Anthony Hooley, Cambridge (GB)

Correspondence Address: HARNESS, DICKEY & PIERCE, P.L.C., P.O. BOX 828, BLOOMFIELD HILLS, MI, 48303, US

(73) Assignee: 1...LIMITED, Cambridge (GB)

(21) Appl. No.: 11/988,667

(22) PCT Filed: Jul. 11, 2006
(86) PCT No.: PCT/GB2006/002556

§ 371 Date: May 13, 2009

(30) Foreign Application Priority Data
Jul. 12, 2005 (GB) 0514361.5

(51) Int. Cl. H04R 5/02

(52) U.S. Cl. 381/303

(57) ABSTRACT

A loudspeaker suitable for the generation of surround-sound effects comprising a plurality of transducers that are together arranged to generate one or more beams of sound, at least one of which beams is steerable, wherein the transducers are arranged to reproduce sound only at frequencies higher than a selected lower frequency limit of 250 Hz or more. The loudspeaker may be foldable or dismantable so as to allow greater portability and may have means for interacting with an external electronics device, for example to allow low frequency sound signals to be reproduced by woofers in the external device.

### FIELD OF THE INVENTION

This invention relates to sound reproduction equipment such as loudspeakers, in particular for directional sound reproduction. In particular it relates to equipment for the reproduction of surround-sound effects.

### BACKGROUND TO THE INVENTION

In domestic settings, the reproduction of surround-sound, such as 5.1 channel surround-sound, generally involves five loudspeakers disposed around the listening room and optionally an additional very-low-frequency speaker or sub-woofer for the low frequency effects (LFE) channel. Recently, sophisticated surround-sound systems employing only a single-cabinet loudspeaker (plus optional LFE speaker) have been described. The single-cabinet loudspeaker comprises an array of transducers operating in a manner similar to a phased array antenna, simultaneously generating multiple directional sound beams corresponding to the 5-channel audio signal. The beams are individually directed around the listening room such that they reach the listener from desired directions (generally centre, front left, front right, rear left, rear right) either directly or following reflection at walls and/or ceiling. This sound directing, or Sound Projector, technology is described for example in co-owned international published patent applications numbered WO 01/23104, WO 02/078388, WO 03/071827 and WO 2004/075601, the disclosures of which are hereby incorporated by reference.

The single-cabinet speakers described in the above-mentioned references are arranged to reproduce full-bandwidth audio, that is, the entire content of each of the five channels (that is, excluding the LFE channel), typically down to a frequency of around 100 Hz. Optimum sound-beam forming and directing is achieved with a small inter-transducer spacing in the array, about 20 mm or thereabouts, necessitating the use of correspondingly small transducers. Such transducers are generally incapable of fully reproducing sound in the lower frequency range of a few hundred Hertz (say 100-600 Hz). In the above-mentioned references, full bandwidth reproduction is nevertheless achieved in one of a number of ways: use of small transducers specially designed to allow greater than normal diaphragm travel, together with over-driving at low frequencies; incorporating speakers of varying diameters to reproduce different frequency ranges; and using simple low-cost small transducers in the array together with two or more larger transducers (woofers) of diameter up to around 100 mm or more to reproduce the lower frequencies. Each of these solutions has the disadvantage either of increased cost for specialised transducers (and possibly additional power supply) or of additional bulk associated with woofers, or both.

It is an aim of the present invention to provide a surround-sound effect system that is both low cost and compact and preferably portable.

### SUMMARY OF THE INVENTION

The present invention provides limited-bandwidth loudspeaker comprising an array of high-frequency transducers arranged to simultaneously generate one or more beams of sound, at least one of which is steerable, wherein the transducers are arranged to reproduce sound only at frequencies higher than a selected lower frequency limit of 250 Hz or more.

It has been found by simulation and experiment that such a limited-bandwidth Sound Projector rather surprisingly produces convincing directional sound effects, even though the sound beams are lacking low frequency content. The listener perceives directional and dynamic sound effects, including surround-sound effects, from such a high frequency array speaker.

The loudspeaker of the invention has the advantage of compactness, as it has no requirement for large-diameter speakers or woofers. For example, the loudspeaker may comprise a line array with small transducers arranged in a horizontal line. The height of the loudspeaker is then little more than the transducer diameter, say 20 mm. Such a speaker is lightweight, and may even be portable (depending on length, and when deemed too long, it may in fact be arranged to fold (for transport) in one or more locations in order to shorten its transportable length). The loudspeaker of the invention also has the potential advantage of low cost, since the transducers comprising the array may be standard small transducers, such as those produced at very low-cost for use in mobile phones for example. The total cost of the array loudspeaker of the invention may be correspondingly low, certainly very much lower than a conventional surround-sound system.

The surround-sound effects system of the invention reproduces only high frequency sound, that is, frequencies above a few hundred Hertz. As is known in the art, such sound is rather “tinny”. Nevertheless, sound of this quality is routinely used in portable devices such as hand-held gaming devices and mobile phones for example. The surround-sound effects system of the invention may therefore be used as an accessory to these devices, providing additional directional sound effects at similar sound quality.

Preferably however, the surround-sound effects system of the invention is used in conjunction with an external device, such as an audio-visual device, comprising its own integral full-bandwidth loudspeakers, through which the lower-frequency content of the audio signal (i.e. that portion of the sound spectrum unable to be reproduced by the loudspeaker of the invention) can be reproduced. Preferably the audio-visual device is a television, a flat-panel display or a computer monitor. Such devices are routinely produced with one or two integral transducers. These transducers are generally 50-100 mm or more in diameter and are capable of reproducing sounds down to frequencies of 75-200 Hz. When used as an accessory to such a device, the surround-sound effects system of the invention therefore provides the directional sound effects while full-bandwidth sound quality is achieved overall through use of both the audio-visual device's speakers and the high-frequency transducers of the array.

The transducer array is driven by control electronics in the manner described in the co-owned patent applications referred to above, to produce one or more steerable sound beams. Preferably, the control electronics includes an additional high-pass filter system to ensure that the signals reaching the array transducers do not include signals with frequencies below the selected limit. This is to ensure that the transducers are not over-driven or saturated.

The lower frequency limit of the high-pass filter is selected depending on the frequency characteristics of the transducers and the length of the array. The frequency limit is selected to be close to or above the rated lower-frequency limit of the transducers, which is typically in the range 250-600 Hz for small transducers, and specifically so for small loudspeakers mass-produced for incorporation in mobile-telephones. As an example, a commercially available 13 mm diameter transducer has a rated lower-frequency limit of 280 Hz, while a commercially available rectangular transducer measuring 11 mm×15 mm is lower-frequency rated at 400 Hz.

The length of the transducer array determines the lowest frequency at which a narrow sound beam can be produced. It has been found by objective and perceptual experiments that a usefully narrow beam can be produced at frequencies whose wavelength is smaller than or similar to the length, or extent, of the array. Thus frequencies above 280 Hz can be usefully beam-steered with an array length of about 1.2 m or more while frequencies above 400 Hz can be steered with an array length of about 0.85 m or more.

In some circumstances, shorter arrays may be desirable on grounds of compactness, portability or low cost. This may be particularly so for the PC/games/TV/music-player accessories market and for use with portable devices. In this case, the lower frequency limit may be selected based on the array length. For example, 680 Hz would be the approximate lower limit for sound beam-steering by a 0.5 m long array and 1100 Hz would be the approximate lower limit for a 0.3 m long array. Although such high-pass filtered sound by itself sounds very thin and tinny, it can nevertheless give a very good sensation or perception of directionality and can be particularly useful for example in computer-games and console-games where many of the directional sound effects, such as speeding bullets, arrows or vehicles, have inherently mainly high frequency content. The overall sound quality is anyway vastly improved, without losing the directional effect of the surround-sound effects system, by reproducing the frequencies below the lower-limiting frequency through conventional speakers, such as those in a television.

The control electronics for the surround-sound effects system of the invention are preferably incorporated within a casing housing the transducer array. The control electronics can include a high-pass filter as described above to ensure the array transducers receive only the high frequency content of the input audio signal. The surround-sound effects system may optionally also separate out the low frequency signals by filtering means and output these lower frequencies for connection to another device such as a television, able to reproduce the low frequency signals through conventional speakers. Alternatively, the television itself, or a connected signal source such as a DVD player, may filter the original audio signal, outputting the low frequency content to the television speakers and the high frequency content to the surround-sound effects system.

The transducer array may be 3-D, 2-D or 1-D and the transducers may be arranged with uniform or non-uniform spacing, as described in the co-owned patent applications referred to above. For compactness and low cost, the transducers are preferably arranged in a one-dimensional line-array. The spacing is preferably non-uniform in the case where the number of transducers used, and the length of the array of transducers, would be such as to produce undesirable full-power alias beams well within the operating frequency band, such array-spacing non-uniformity being optimised to minimise the unwanted perceptual effects of the alias beams and sidelobes of the array.

The array includes at least 4 transducers but preferably 10 or more transducers. A greater number of transducers improves the sound intensity and the beam forming capability. Thus higher quality sound and sound-direction perception is produced from an array with 15-20 transducers, or even with 50 or more transducers.

The surround-sound effects system of the invention may be implemented as a modular system. A single module, for example an array of 15 transducers arranged in a line array measuring about 300 mm long, produces directional beams at appropriately high frequencies (e.g. for 300 mm length, above about 1.1 KHz). Suitable physical and electrical connectors can be provided on the module such that further modules may be added, for example another similar module at one end or each end of the first module. Suitable electronics to detect the presence of the additional modules (which could be as simple as connector links/pins closed by the connection of an adjacent module), and to process the sound signals accordingly are provided in at least the first or core module. The two- or three-module combination is then effectively a 600 mm or 900 mm long array respectively with 30 or 45 transducers, producing louder sound, tighter beams and steerable beams down to a lower frequency. In this example, the single module may usefully steer beam frequencies down to 1100 Hz while the combinations may steer beam frequencies down to 570 Hz or 380 Hz respectively. Thus the user has the option to upgrade their system by adding one or more modules. Each module may be very compact and thus portable.

Modules may also be connected or stacked vertically in a similar manner (again using suitable connectors and control electronics to support the newly formed (stacked) array shape) to allow vertical beam-steering as well as the horizontal beam-steering available from a horizontal line array.

Another portable variant is a line array foldable into two or more sections. Suitable hinges and electrical connections can be provided at the folds, such that the array may be folded into two or three or more sections for transport, and unfolded for use.

The foldable variant also has the advantage of allowing at least two modes of operation. Taking the example of a line array that is foldable in half so as to create two stacked line arrays half the length of the original line array, the array can be used either in the original line configuration or in the stacked configuration. The same array can therefore be used in two different modes.

The loudspeaker of the present invention is capable of generating one or more beams of sound. Such beams are preferably generated by arranging for the sound signal to be appropriately delayed at respective transducers such that the sound pressure level at points inside the beam is higher than at points outside of the beam. The beam can be made relatively narrow (especially at higher frequencies) even though the transducers themselves may be substantially omnidirectional. Appropriate circuitry for generating the delays used to create a beam is disclosed in our previously mentioned published patent applications.

### BRIEF DESCRIPTION OF THE DRAWINGS

The present invention will now be further described, by way of non-limitative example only, with reference to the accompanying schematic drawings, in which:—

FIG. 1 is a perspective drawing of an embodiment of the surround-sound effects system of the invention;

FIG. 2 shows the embodiment of FIG. 1 used together with a television;

FIG. 3 is a plan view of the sound field that may be created by the system shown in FIG. 2;

FIG. 4 is a perspective drawing of a further embodiment of the invention;

FIG. 5 illustrates a modular embodiment of the invention comprising three modules arranged horizontally;

FIG. 6 illustrates a modular embodiment of the invention comprising four modules arranged vertically; a

FIGS. 7A and 7B are perspective drawings of a portable foldable embodiment of the invention;

FIG. 8 illustrates control electronics according to the invention.

### DETAILED DESCRIPTION

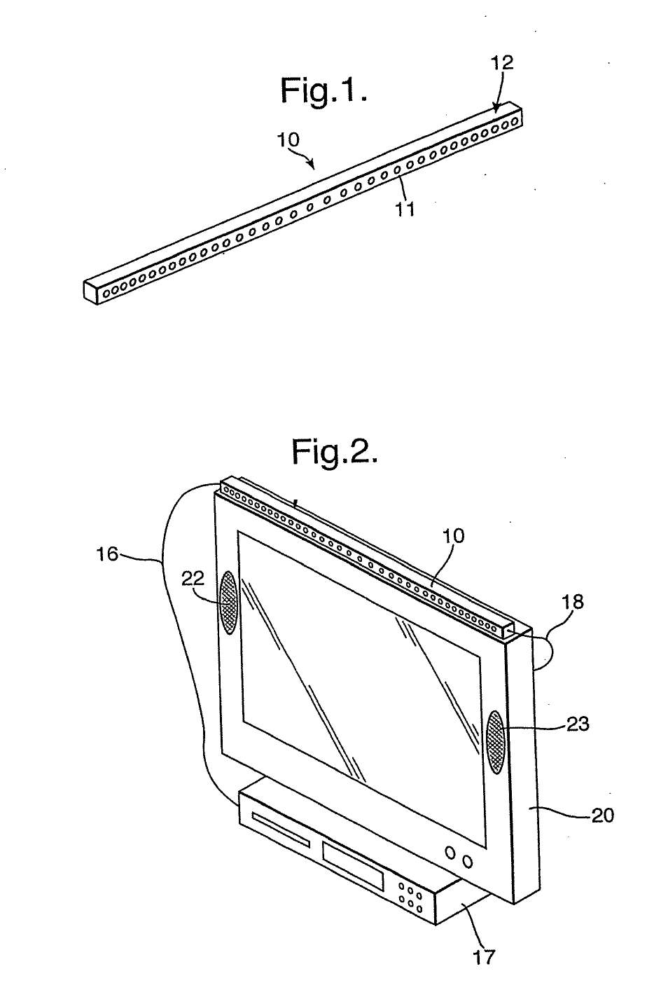

FIG. 1 is a perspective view of an embodiment of a compact surround-sound effects system, or loudspeaker, of the invention. The loudspeaker 10 comprises an array of high-frequency transducers 11 here arranged in a line. The transducer drivers and control electronics (not shown) may be housed within the speaker case 12.

The transducers 11 are small circular speakers measuring 13 mm in diameter with a lower frequency cut-off of about 280 Hz and power rating of 100 mW. The loudspeaker here measures 800 mm long by 20 mm high by 40 mm deep. The array comprises 50 transducers arranged with non-uniform inter-transducer spacing, the spacing between adjacent transducers being larger towards the centre of the array and smaller towards each end of the array. The horizontal length of the array is 800 mm, indicating that it is capable of steering sound-beams with wavelengths shorter than about 800 mm, that is, frequencies above about 425 Hz. Modelling and experiments show that such an array may produce a Sound Pressure Level (SPL) of about 90 dB at 1 m.

As the array is a line array, it is capable of directing one or more sound beams in directions in a horizontal plane parallel with the centre line of the transducers. If the loudspeaker is oriented vertically, the sound beams may therefore be directed vertically.

The surround-sound generator of FIG. 1 can be used on its own as a stand-alone loudspeaker system. It can be arranged to receive a standard 5.1 channel sound signal so as to create the five beams of sound necessary in the surround sound system. Alternatively or additionally, it can be used with an external device incorporating its own wideband speakers or woofers. An example of such implementation is shown in FIG. 2, illustrating a flat panel television 20 with internal speakers 22, 23, with a loudspeaker of the invention 10 mounted above. The TV shown is a 32 inch model, measuring about 800 mm across. The loudspeaker of the invention supplements sounds emanating from the TV speakers, providing surround-sound effects.

As an example, the signal path will be described for playing back a 5.1 channel surround-sound signal. The 5.1 channel audio signal originates for example in a DVD player 17 when a DVD is played or within a high definition television (HDTV) receiving a surround-sound enabled programme. The DVD player or HDTV supplies the 5.1 channel audio signal to the loudspeaker via a suitable cable 16. The signal processor within the surround-sound generator filters out (removes) the low-frequency content, that is the content below the selected cross-over frequency (about 400 Hz in the example of FIG. 1), of each of the 5 surround-sound channels and adds the removed low frequency content of each channel to the input low frequency channel (the .01 channel) signal. This modified summed low frequency signal is output from the loudspeaker via a cable 18 to the television, where it drives the televisions integral wide bandwidth (‘woofer’ or low-frequency capable) speakers 22, 23. The modified high-pass filtered surround-sound channel signals, now containing only high frequency signals, are further processed within the loudspeaker to impart directionality to the output sound-beams of each of the channels, primarily by adding suitable per-transducer delays in the manner described in the co-owned patent applications. These signals then drive the transducers 11 of the array to output beams of high-frequency sound. The listener then hears low-frequency sound from the TV loudspeaker(s) 22, 23 and high-frequency sounds from around the room as the sound-beams are reflected from walls.

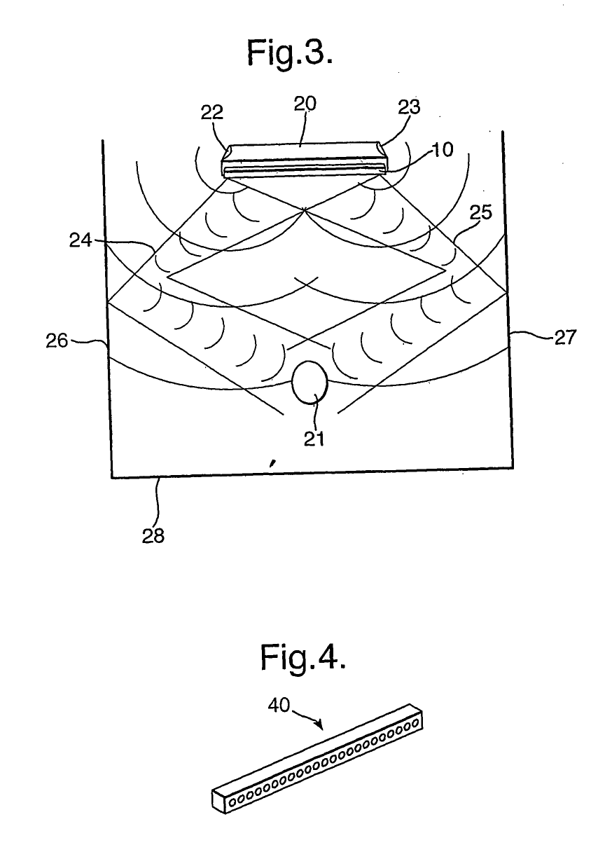

This is illustrated in FIG. 3 which schematically shows from above the TV 20, the loudspeaker 10 and the listener 21 within a listening room. In this case, the loudspeaker 10 is positioned just in front of the TV 20. As is common in flat panel televisions, two speakers 22, 23 are built-in. The low-frequency sound signals are reproduced by the TV speakers 22 and 23, generating omni-directional low-frequency sound, as indicated by the large wavefronts (part-circles in the figure). The loudspeaker 10 meanwhile reproduces individual high-frequency directional beams of sound, two of which 24, 25 are shown, representing the left-front and right-front channels. These beams are directed to the side-walls 26, 27 respectively of the listening room, so that they are reflected and reach the listener from front-left and front-right. In a 5.1 surround-sound system, three further channels (not shown for clarity) are reproduced by the surround-sound generator: a centre channel directed towards the listener; and rear-left and rear-right channels directed towards the rear of the room to be reflected off the side (26 and 27) and back (28) walls to reach the listener 21 from behind. It is important to note that even though the 5 surround-sound channels contain only high-frequency sounds, the surround-sound at the listener position is nevertheless convincing, as the ear is generally much more sensitive to directionality at high-frequencies than at low-frequencies.

A further embodiment of the invention is shown in FIG. 4. In this case, the loudspeaker 40 is shorter, of the order of 300 mm long, with an array of 15 transducers. Height and depth dimensions are similar to the example of FIG. 1 (20-40 mm). At this size, the surround-sound generator is very compact and even portable and thus particularly suitable as an accessory for a personal computer, a games console, a hand-held gaming device, a portable music player, a small TV and portable devices such as mobile phones and personal digital assistants. As before, the frequencies which can be steered are a function of the length of the array, in this case 300 mm, indicating a cross-over frequency of about 1 kHz. Incoming audio signals can therefore be processed to filter out the low-frequency, below 1 kHz signals, and the array reproduces sound above this frequency only. The low-frequency content can be reproduced through speakers within the device to which the loudspeaker 40 is an accessory. Although the directional sound-beams are high-frequency only, considerable directionality is perceived by the listener. In particular, many of the dynamic effects in computer and console games for example (such as speeding bullets, fast-moving vehicles etc) are inherently mainly high-frequency sounds, such that the loudspeaker greatly enhances the spatial effects.

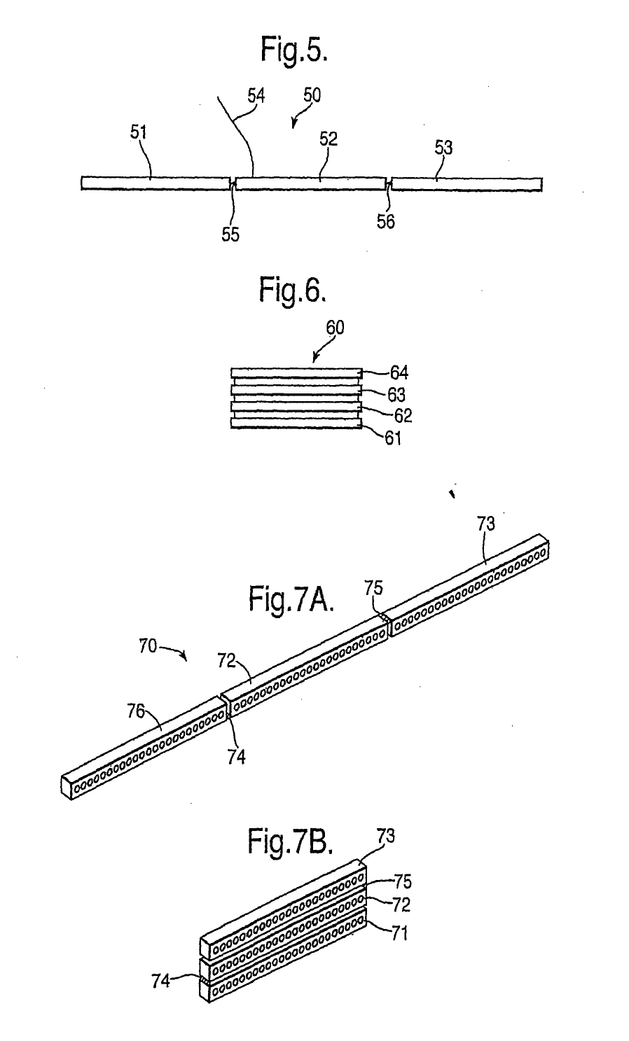

The short loudspeaker 40 of FIG. 4 may act as, or be configured as, a module in a modular system. An example of three such modules 51, 52, 53 connected together end to end is shown in FIG. 5. The three modules together form a surround-sound generator 50 of total length about 900 mm, thus enabling steering of sound down to frequencies of about 350 Hz, considerably improving the perceived directionality compared to a single module system, such as that shown in FIG. 4. One of the modules, 52 in this example although it does not need to be the centre module, acts as core module and receives input signals from the external device (TV or games console for example) via a connecting cable 54. This module 52 has additional processing capacity to firstly detect the presence of the other modules and secondly to select an appropriate cross-over frequency and appropriate signal delays to each of the transducers. Power and drive signals are transmitted from the core module 52 to the other modules 51 and 53 through the end connectors 55 and 56.

The end connectors 55 and 56 may take any suitable form and may be embodied by a single connector that both physically and electrically connects the module or by separate physical and electrical connectors. For example, the modules 51, 52, 53 may be arranged to snap-fit or slide-lock together, such snap-fitting or slide-locking also serving to bring together electrical contacts.

In an alternative system where the control module is designed to be at the end of the array, the additional modules may be designed to “daisy-chain” one to the next without practical limit to allow large arrays to be constructed from identical modules. Such a modular system has significant benefits to the user as a loudspeaker comprising a single module can at a later date be upgraded by supplementing it with further modules at the user's wish, each additional module improving the quality of the surround-sound. Three modules are shown in FIG. 5 but clearly 2, 4 or more modules are equally possible.

An alternative modular concept is shown in FIG. 6. Here four modules 61, 62, 63 and 64 are arranged vertically to form a two-dimensional array loudspeaker 60. Such an array is capable of vertical beam steering as well as the horizontal beam steering available from line arrays. This may be particularly appropriate for example for games employing overhead and underfoot sound effects. The modules 61, 62, 63, 64 may be simply stacked one on top of the other, which such stacking perhaps being assisted by detents and recesses in the connecting surfaces of the modules. The modules may also be physically connected together in any suitable way and of course will be electrically connected.

The electrical connections of FIGS. 5 and 6 are suitable for allowing the appropriate sound signals to be routed to the appropriate transducers. The electrical connections may also be used to allow the sensing of the presence of further modules.

The module 40 of FIG. 4 is readily portable, with a length of only about 300 mm and a volume of only about 240 cm³ (30×2×4 cm). A further portable embodiment of the invention is shown in FIGS. 7A and 7B. Here a longer array 70, similar to the 800 mm array of FIG. 1, is divided into three sections 71, 72 and 73 hingeably connected together at hinges 74 and 75. The array 70 is foldable into the compact configuration illustrated in FIG. 7B. For use as a long line array, the array 70 is unfolded into the configuration of FIG. 7A. The electrical connections between the various sections of such a hinged modular array may be provided in several convenient ways, including flexible cables near to the hinge axes (e.g. ribbon cables), or by connectors on the module section ends which make and break contact as the array is hinged out to its long configuration and folded up to its short transportable form.

The compact configuration shown in FIG. 7B may be non-operational or operational. If it is non-operational, this configuration is used to allow the array to be easily transported. Alternatively, the electrical connection between the modules can be maintained both in the folded and unfolded state to allow the array of FIG. 7B to be used in situations where some vertical beam directivity is useful.

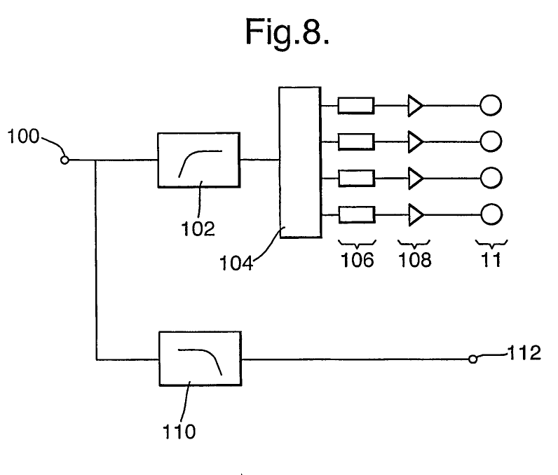

FIG. 8 shows some control electronics that may be used in the loudspeaker. A sound signal is presented at input port 100 and is high-pass filtered by high-pass filter 102 so as to remove the low frequency components below a selected lower frequency limit. In this example the lower frequency limit is 250 Hz although it could take other values such as 400 Hz. The sound signal is thereafter replicated by replicator 104 so as to produce a plurality of identical sound signals (four in this example). Each signal is then delayed by a respective controllable delay element 106. The delay is selected in order to provide a beam of sound from the array in accordance with the teachings of our earlier patent applications. The signals are thereafter amplified by amplifiers 108 before being routed to transducers 11.

FIG. 8 is necessarily a simplified example. With more transducers, more delay elements and amplifiers are required. Furthermore, when there is more than one input signal (as there will be in a 5.1 surround sound system) the electronics of FIG. 8 can be duplicated with the signals being linearly added together before being routed to the power amplifiers or transducers. An example for two input signals is shown in FIG. 11 of WO 01/23104 and it is readily apparent how one may expand this to the five or more signals required in a surround-sound system.

FIG. 8 also shows an optional low-pass filter 110 which filters the input signal and provides the filtered result to an output port 112. This signal can thereby be transferred to an external device (such as a television) to allow the low frequency content of the signal that is input at input port 100 to be reproduced by the external device.

The high-pass filter 102 and low-pass filter 110 are preferably selected such that the low frequency content that is not routed to the transducers 11 is instead routed to the external device via output port 112. This is not, however, necessary and the low-pass filter 110 may have a cut-off point set at a value which allows it to pass some of the signal that the high pass filter 102 also allows to pass. For example, the high-pass filter 102 can have a cut-off of 250 Hz and the low-pass filter 110 can have a cut off of 500 Hz.

1. A limited-bandwidth loudspeaker comprising an array of high-frequency transducers arranged to simultaneously generate one or more beams of sound, at least one of which is steerable, wherein all the transducers in the loudspeaker are arranged to reproduce sound only at frequencies higher than a selected lower frequency limit of 250 Hz or more.

2. A loudspeaker according to claim 1, wherein all of said transducers are the same physical size.

3. A loudspeaker according to claim 1, wherein said transducers have a diameter or major dimension of 153 mm or less.

4. A loudspeaker according to claim 1, wherein said lower frequency limit is 400 Hz or more.

5. A loudspeaker according to claim 1, which loudspeaker is a module of a modular system, said module comprising means for physically and electrically interacting with other modules in the system.

6. A loudspeaker according to claim 1, further comprising at least one hinge to allow the loudspeaker to be folded into a plurality of sections.

7. A loudspeaker according to claim 6, wherein said loudspeaker is operatable in both said folded and unfolded configurations.

8. A loudspeaker according to claim 1, wherein the array of transducers is a one-dimensional array.

9. A loudspeaker according to claim 8, wherein the spacing between adjacent transducers is greater in the centre of the array than at the ends of the array.

10. A loudspeaker according to claim 9, wherein the spacing gradually decreases towards the ends of the array.

11. A loudspeaker according to claim 1, further comprising a port for connection to an external device.

12. A loudspeaker according to claim 11, wherein said port is an output port for providing low frequency sound signals to the external device.

13. A loudspeaker according to claim 12, further comprising an input port for receiving sound signals comprising at least a high frequency component for output by the loudspeaker.

14. A loudspeaker according to claim 11, wherein said port is an input port for receiving sound signals comprising at least a high frequency component for output by the loudspeaker.

15. A loudspeaker according to claim 1, wherein said transducers are physically capable of reproducing acceptable sound only at frequencies higher than said selected lower frequency limit.

16. A loudspeaker according to claim 1, further comprising a casing housing the transducer array.

17. A loudspeaker according to claim 16, further comprising control electronics housed in said casing.

18. A loudspeaker according to claim 17, wherein said control electronics include a low pass filter and said low frequency signals that are filtered are provided to an output port.

19. A loudspeaker according to claim 18, wherein said control electronics include one or more high pass filters arranged to filter signals routed to the transducers to remove any component below the selected lower frequency limit.

20. A loudspeaker according to claim 17, wherein said control electronics comprises elements arranged to delay signals routed to respective transducers so as to form said one or more beams of sound.

21. A loudspeaker according to claim 20, wherein said control electronics further comprises elements that allow the respective delays to be altered thereby allowing the direction of the beam to be steered.

22. A loudspeaker according to claim 1, wherein said array comprises at least 10 transducers.
